(19) United States
(12) Patent Application Publication
(10) Pub. No.: US 2009/0124532 A1
(43) Pub. Date: May 14, 2009

(54) Detergent Granule and Process for Production Thereof

(76) Inventors: Yushi Sakata, Wakayama (JP); Makoto Takahashi, Wakayama (JP); Tsutomu Tokumoto, Wakayama (JP)

Correspondence Address: BIRCH STEWART KOLASCH & BIRCH, PO BOX 747, FALLS CHURCH, VA, 22040-0747, US

(21) Appl. No.: 11/988,090

(22) PCT Filed: Jul. 10, 2006
(86) PCT No.: PCT/JP2006/313652

§ 371 Date: Dec. 31, 2007

(30) Foreign Application Priority Data
Jul. 12, 2005 (JP) 2005-203419

(51) Int. Cl. C11D 17/06

(52) U.S. Cl. 510/444

(57) ABSTRACT

[Problems] To provide detergent granules capable of suppressing paste formability and having low exothermic property; a process for producing the detergent granules; and a high-bulk density detergent composition containing the detergent granules. [Solving Means] Detergent granules containing a sodium linear alkylbenzenesulfonate (LAS-Na), sodium sulfate undetected by X-ray diffraction method and sodium sulfate detected by X-ray diffraction method, wherein a molar ratio of [sodium sulfate undetected by X-ray diffraction method]/[LAS-Na] is from 0.1 to 1.0, and a molar ratio of [sodium sulfate detected by X-ray diffraction method]/[chemically quantified sodium sulfate] is from 0.5 to 0.9; a process for producing detergent granules, including the step of dry-neutralizing a mixture of a liquid acid precursor of a sodium linear alkylbenzenesulfonate (LAS-S) and sulfuric acid with a water-soluble solid alkali inorganic substance in a mixture containing powdery anhydrous sodium sulfate, wherein sulfuric acid is present in a ratio of 0.1 to 1.0 mol to one mol of the LAS-S, and the powdery anhydrous sodium sulfate is present in a ratio of from 0.5 to 0.9 mol to one mol of a total of the powdery anhydrous sodium sulfate and sulfuric acid; and a high-bulk density detergent composition having a bulk density of 500 g/L or more, containing the detergent granules as defined above, or detergent granules obtainable by the process as defined above.

### TECHNICAL FIELD

The present invention relates to detergent granules containing a sodium linear alkylbenzenesulfonate (hereinafter referred to as “LAS-Na”) and sodium sulfate. The present invention relates to a process for producing the detergent granules by dry-neutralization. Further, the present invention relates to a high-bulk density detergent composition containing the detergent granules.

### BACKGROUND ART

In industrial circles of detergent, a process for producing a powder detergent having a relatively high bulk density has been recently remarked. This kind of powder containing LAS-Na is produced while neutralizing in situ an acid precursor of the above-mentioned sodium linear alkylbenzenesulfonate (hereinafter referred to as “LAS-S”) with an alkali such as sodium hydroxide or sodium carbonate.

For example, Patent Publication 1 discloses a process including the step of adding a liquid acid precursor to fluidized, granular solid alkali inorganic substance and recycled fine powder to neutralize.

However, this publication does not clearly define the compositions of the recycled fine powder, and there are no descriptions or suggestions on paste formability upon using a detergent in a washing machine, and exothermic property when hand-washing is carried out.

Patent Publication 1: JP 2002-528599 A

### DISCLOSURE OF THE INVENTION

### Problems to be Solved by the Invention

An object of the present invention is to provide detergent granules capable of suppressing paste formability and having low exothermic property.

Another object of the present invention is to provide a process for producing the detergent granules.

A still another object of the present invention is to provide a high-bulk density detergent composition containing the detergent granules.

### Means to Solve the Problems

In sum, the present invention relates to:
[1] detergent granules containing a sodium linear alkylbenzenesulfonate (LAS-Na), sodium sulfate undetected by X-ray diffraction method and sodium sulfate detected by X-ray diffraction method, wherein a molar ratio of [sodium sulfate undetected by X-ray diffraction method]/[LAS-Na] is from 0.1 to 1.0, and a molar ratio of [sodium sulfate detected by X-ray diffraction method]/[chemically quantified sodium sulfate] is from 0.5 to 0.9;
[2] a process for producing detergent granules, including the step of dry-neutralizing a mixture of a liquid acid precursor of a sodium linear alkylbenzenesulfonate (LAS-S) and sulfuric acid with a water-soluble solid alkali inorganic substance in a mixture containing powdery anhydrous sodium sulfate, wherein sulfuric acid is present in a ratio of 0.1 to 1.0 mol to one mol of the LAS-S, and the powdery anhydrous sodium sulfate is present in a ratio of from 0.5 to 0.9 mol to one mol of a total of the powdery anhydrous sodium sulfate and sulfuric acid; and
[3] a high-bulk density detergent composition having a bulk density of 500 g/L or more, containing the detergent granules as defined in the above [1], or detergent granules obtainable by the process as defined in the above [2].

### Effects of the Invention

By using the process described in the present invention, some effects that detergent granules in which paste formability at bottom of a washing machine is very low, and the generation of unpleasant heat of dissolution upon hand-washing is low can be obtained are exhibited.

### BEST MODE FOR CARRYING OUT THE INVENTION

The process for producing detergent granules of the present invention is a process for producing detergent granules, including the step of dry-neutralizing a mixture of a liquid acid precursor of a sodium linear alkylbenzenesulfonate (LAS-S) and sulfuric acid with a water-soluble solid alkali inorganic substance in a mixture containing powdery anhydrous sodium sulfate, and the features of the process reside in that sulfuric acid is present in a ratio of 0.1 to 1.0 mol to one mol of the LAS-S, and that the powdery anhydrous sodium sulfate is present in a ratio of from 0.5 to 0.9 mol to one mol of a total of the powdery anhydrous sodium sulfate and sulfuric acid.

In the present invention, according to the above process, detergent granules and a high-bulk density detergent composition can be produced. In other words, detergent granules obtainable by dry-neutralizing LAS-S with a water-soluble solid alkali inorganic substance in the intentional presence of sulfuric acid are detergent granules that have low adhesion of the granules and small particle sizes.

However, detergent granules having smaller particle sizes are likely to form paste upon use in a washing machine. In addition, in conventional detergent granules, when the content of the water-soluble solid alkali inorganic substance is high, generation of heat of the detergent granules is felt upon hand-washing, thereby giving unfavorable feel to a user. On the other hand, there are some advantages that paste is not formed and that the generation of heat is controlled to a tolerable level by adding powdery anhydrous sodium sulfate upon carrying out dry-neutralization as in the present invention, even in a case where particle sizes are small.

The embodiment of dry-neutralization in the process of the present invention is not particularly limited, as long as the embodiment is capable of carrying out dry-neutralization in the presence of given amounts of sulfuric acid and powdery anhydrous sodium sulfate. The embodiment includes, for example, an embodiment including the step of mixing a mixture of a LAS-S and sulfuric acid, a water-soluble solid alkali inorganic substance, and a powdery anhydrous sodium sulfate to carry out dry-neutralization.

The above embodiment will be described more specifically hereinbelow as one example of the process of the present invention.

In the present embodiment, the process can be divided into each of the steps of 1) a mixing step, and 2) a dry-neutralizing step. Next, each of the steps will be described.

1) Mixing Step

This step includes the step of, prior to dry-neutralizing, previously mixing a LAS-S and sulfuric acid.

In addition, among the LAS-S's usable in the present invention, residual sulfuric acid may be contained in some cases depending on their production process.

The LAS-S (linear alkylbenzenesulfonic acid) usable in the present invention is produced by the following representative two processes:
(1) Oleum (fuming sulfuric acid) sulfonation process
(2) SO₃ gas sulfonation process

(1) is a classical process for producing a linear alkylbenzenesulfonic acid, wherein sulfuric acid may be contained in the resulting product in an amount of about 0.3 mol per one mol of the linear alkylbenzenesulfonic acid. Also, in (2), the purity of the linear alkylbenzenesulfonic acid in the resulting product is high, and the amount of residual sulfuric acid is relatively low, wherein the amount of residual sulfuric acid is usually at a level of 0.2 mol or less per one mol of the linear alkylbenzenesulfonic acid.

Presently, from the aspects of quality and productivity, the process (2) is mainly employed as a process for producing a linear alkylbenzenesulfonic acid in high purity. In the present invention, the linear alkylbenzenesulfonic acid produced by (2) is preferably used.

As mentioned above, sulfuric acid may previously be present in the LAS-S in some cases. The amount of sulfuric acid previously present in the LAS-Na, is not particularly limited. From the viewpoint of hue of the resulting detergent granules, the amount of sulfuric acid previously present in the LAS-Na is preferably 0.09 mol or less, more preferably 0.06 mol or less, per one mol of the LAS-S. Here, it is preferable that the alkyl group in the LAS-S has 10 to 16 carbon atoms.

The amount of sulfuric acid that is allowed to be present in the process of the present invention is from 0.1 to 1.0 mol per one mol of the LAS-S, and preferably from 0.1 to 0.8 mol, and more preferably from 0.15 to 0.65 mol, per one mol of the LAS-S. From the viewpoint of inhibiting the formation of coarse granules of the detergent granules, the amount of sulfuric acid is preferably 0.1 mol or more, and from the viewpoint of securing the compositional freedom of a concentrated detergent, the amount of sulfuric acid is preferably 1.0 mol or less.

In addition, the amount of the powdery anhydrous sodium sulfate and the amount of the above sulfuric acid that are allowed to be present in the present invention are preferably in a ratio such that the powdery anhydrous sodium sulfate is in an amount of from 0.5 to 0.9 mol, and preferably from 0.6 to 0.88 mol per one mol of a total of the powdery anhydrous sodium sulfate and sulfuric acid. From the viewpoint of inhibiting the formation of paste in a washing machine, the amount of the powdery anhydrous sodium sulfate is 0.5 mol or more, and from the viewpoint of inhibiting the formation of coarse granules of the detergent granules, the amount of the powdery anhydrous sodium sulfate is preferably 0.9 mol or less.

Here, when the amount of sulfuric acid that is previously present in the LAS-S does not satisfy the above range, or when it is desired to obtain even smaller detergent granules even if the amount of sulfuric acid that is previously present in the LAS-S satisfies the above range, it is preferable that sulfuric acid is intentionally added to raw material components such as LAS-S.

The mixer usable in this step is not particularly limited, and includes, for example, a liquid mixing vessel equipped with an agitator, and the like.

In addition, the extent of mixing may be preferably such that each component is homogeneously mixed. Other conditions upon mixing (temperature, nitrogen replacement in the head space portion of the agitator) are not particularly limited.

2) Dry-Neutralizing Step

This step includes the step of mixing a mixture of the LAS-S and sulfuric acid obtained in the previous step, and a water-soluble solid alkali inorganic substance and a powdery anhydrous sodium sulfate, thereby carrying out dry-neutralization of the LAS-S and sulfuric acid. Here, in this step, by adding the LAS-S and sulfuric acid, neutralization reaction and granulation take place concurrently, thereby forming neutral granules.

Specifically, this step includes the following step (a) and step (b).

In other words, the step includes the steps of:
(a) blending a water-soluble solid alkali inorganic substance, a powdery anhydrous sodium sulfate, and/or a known substance generally used in a detergent composition, wherein the water-soluble solid alkali inorganic substance is contained in an amount equal to or greater than that required for neutralizing a mixture of the LAS-S and sulfuric acid (amount equivalent for neutralization) in the mixture obtained in the above-mentioned mixing step; and
(b) adding the mixture of the LAS-S and sulfuric acid obtained in the above-mentioned mixing step to the mixture obtained in the step (a), thereby neutralizing the mixture obtained in the step (a) while keeping its granular form.

Step (a)

The water-soluble solid alkali inorganic substance includes those ordinarily usable as alkalizing agents in a detergent composition, and is exemplified by sodium carbonate, sodium hydrogencarbonate, sodium silicate, potassium carbonate, and the like. These water-soluble solid alkali inorganic substances may be used alone or in admixture of two or more kinds. Among the water-soluble solid alkali inorganic substances, a preferred embodiment is sodium carbonate, and sodium carbonate can function as a detergent builder and an alkalizing agent in a final composition. Therefore, a neutralization reaction can be favorably carried out by adding the water-soluble solid alkali inorganic substance in this step while mixing in an amount resulting from the total of the amount necessary for neutralizing the mixture of the LAS-S and sulfuric acid and the amount of sodium carbonate for the above function.

Specifically, the amount of the water-soluble solid alkali inorganic substance is preferably an amount substantially larger than the amount required for neutralizing the LAS-S and sulfuric acid (amount equivalent for neutralization). For example, the amount of the water-soluble solid alkali inorganic substance is preferably from 1 to 20 times, more preferably from 2 to 15 times, and even more preferably from 3 to 10 times, the amount equivalent for neutralization.

The powdery anhydrous sodium sulfate usable in the present invention refers to sodium sulfate having a molar percentage of sodium sulfate decahydrate of 50% or less. Here, the molar percentage can be confirmed by drying a standard sample at 100° C. to a constant volume to give an anhydrous form.

The powdery anhydrous sodium sulfate includes one under the trade name of “neutral anhydrous sodium sulfate” (manufactured by Shikoku Kasei Kogyo K.K.), and the like.

Here, a powder refers to granules having an average particle size of from 50 to 500 μm.

Further, in this step, a known substance that is generally usable in a detergent composition may be added and mixed. The substance includes tripolyphosphates, crystalline or amorphous alkali metal aluminosilicates, crystalline silicates, calcium carbonate, fluorescers, pigments, anti-redeposition agents (polycarboxylate polymers, carboxymethyl cellulose sodium, and the like), granular surfactants (fatty acids or salts thereof, alkyl sulfates, and the like), spray-dried powders, diatomaceous earth, calcite, kaolin, bentonite, sodium sulfite, and the like. The substance is optionally used depending upon its applications.

For example, in this step, when an alkali metal aluminosilicate is added, a water-insoluble component is generated.

The term “water-insoluble component” as used herein refers to a component obtained by placing 1 L of water at 10° C. in a 1 L beaker, supplying 1 g of detergent granules thereto, stirring the mixture with a magnetic stirrer for 10 minutes, sieving through a sieve having a sieve-opening of 200 mesh (74 μm), drying the sieve-passed granules at 105° C. for 30 minutes, and weighing the residual component. When the water-insoluble component exceeds 0.5% by weight, it is not preferable because the user can recognize the component.

In this step, when the alkali metal aluminosilicate is supplied in an amount exceeding 5% by weight of a final detergent composition, a water-insoluble component would exceed 0.5% by weight. Therefore, in this step, when the alkali metal aluminosilicate is further added, the amount of the alkali metal aluminosilicate is preferably 5% by weight or less, and more preferably 3% by weight or less, of the resulting detergent granules. For this reason, it is desired that the aluminosilicate that is necessary from the viewpoint of design of a detergent is supplied in a step after the dry-neutralization.

The alkali metal aluminosilicate has an average particle size of preferably from 1 to 30 μm.

Here, the average particle size of the above aluminosilicate is calculated on volume basis, which is a value determined with a laser diffraction type particle size analyzer LA-500 (manufactured by HORIBA, Ltd.).

In addition, the amount of the crystalline silicate, calcium carbonate, the fluorescer, the pigment, the anti-redeposition agent, the granular surfactant, the spray-dried powder, diatomaceous earth, calcite, kaolin, bentonite, sodium sulfite or the like is not particularly limited.

A mixer for mixing each of the above components, usable in the step (a) is not particularly limited. An agitation granulator is preferably used. The agitation granulator is not particularly limited, and one equipped with agitation blades and a chopper for disintegration and dispersion (or one equipped with a means functionally equivalent thereto) is preferable.

Specific examples of the agitation granulators usable in the present invention for a batch process include Vertical Granulator (manufactured by Powrex Corp.); High-Speed Mixer (manufactured by Fukae Powtec Kogyo Corp.); Lödige Mixer (manufactured by Matsubo Co., Ltd.); and PLOUGH SHARE Mixer (manufactured by PACIFIC MACHINERY & ENGINEERING Co., LTD.); Gericke Mixer (manufactured by Meiji Machine Co., Ltd.), and the like. Here, particular preference is given to the Lödige Mixer and the PLOUGH SHARE Mixer. The agitation granulators usable for a continuous process include continuous Lödige Mixer (moderate speed mixer: those having relatively long residence time); CB recycler (manufactured by Lödige) as a high-speed mixer: those having relatively short residence time); Turbilizer (manufactured by Hosokawa Micron Corporation); Shugi Mixer (manufactured by Powrex Corp.); Flow Jet Mixer (manufactured by Funken Powtechs, Inc.), and the like. Incidentally, in the present invention, the above mixers may be properly used in combination.

Also, it is more preferred that the agitation granulator is equipped with a jacket for adjusting the internal temperature of the agitation granulator, or with a nozzle for carrying out the procedures of blowing a gas into the agitation granulator.

The extent of mixing in step (a) is not particularly limited, and mixing may be preferably carried out to an extent such that each of the components is homogeneously mixed. For example, in the case where the agitation granulators are used in this step, the operating conditions of the agitation granulators may be, for example, a blending time of preferably within five minutes. The agitating speed of the main shaft and the chopper speed for disintegration and dispersion may be properly set depending on the kinds of the mixers used. For example, in the case of mixers for a batch process, the peripheral agitating speed of the main shaft is preferably from 2 to 15 m/s, and the peripheral chopper speed for disintegration and dispersion is preferably from 20 to 60 m/s.

Step (b)

In step (b), in order to carry out the dry-neutralization of the LAS-S, the LAS-S or a mixture of the LAS-S and sulfuric acid may be gradually added to the water-soluble solid alkali inorganic substance. The time required for the addition of the LAS-S or the above mixture cannot be unconditionally determined because the time required depends upon the amount of the LAS-S or the above mixture added. In the case for a batch process, the time required is generally one minute or more, more preferably from 1 to 10 minutes, and even more preferably from 2 to 7 minutes. Here, when the LAS-S or the above mixture is added in an extremely short time period, the unreacted LAS-S accumulates, thereby making it likely to cause excessive agglomeration. Therefore, it is preferred that the LAS-S or the above mixture is added in one minute or more.

Also, as the process of addition, the LAS-S or the above mixture may be added continuously or in divided plural portions. Also, the addition means may be provided by the plural numbers of adding apparatuses or methods.

Incidentally, the mixers that can be used in step (b) are not particularly limited, with a preference given to the agitation granulators exemplified in the above step (a).

After the addition of the LAS-S or the above mixture, the agitation granulator may be operated for additional 30 seconds or more, and more preferably one minute or more. By carrying out this procedure, it is preferable because the neutralization reaction and the granulation procedures can be completed. s

In step (b), it is preferred that the neutralization is carried out while blowing a gas thereinto. This step is carried out in order that the excess water produced in the neutralization reaction can be evaporated and the granular product can be cooled with the gas, to thereby inhibit the granular product from forming into a larger lump. The gases which may be usable include an N₂ gas, the air, and the like. The amount of gas blown (amount of gas flow) is not particularly limited. The gas is blown at a rate of preferably equal to or greater than 0.2 parts by weight per minute, and more preferably equal to or greater than 2 parts by weight per minute, based on 100 parts by weight of the granular product.

In addition, when a soap (fatty acid salt of sodium) is contained in the composition of a desired detergent composition, in the step (b), a fatty acid is optionally added to carry out dry-neutralization of a fatty acid. The order of addition is such that it is desired that the fatty acid is added after addition of the LAS-S or the mixture of the LAS-S and sulfuric acid, and it is more desired that the fatty acid is added after addition of the LAS-S or the mixture of the LAS-S and sulfuric acid and the subsequent operation of the agitation granulator for additional 30 seconds or more, and more preferably 1 minute or more. This is because the LAS-S or sulfuric acid is reacted with the fatty acid when the neutralization of the LAS-S and sulfuric acid is not completed to form a colored substance, thereby deteriorating the external appearance of the manufactured article in some cases. Here, a soap may be added in place of adding a fatty acid in an optional step after addition of the LAS-S or the mixture of the LAS-S and sulfuric acid.

In the manner as described above, the dry-neutralization step is completed.

The detergent granules obtainable by the process of the present invention described above may be subjected to surface modification. In other words, the process for producing the detergent granules of the present invention may further include the step of adding a free-flowing aid to the detergent granules after the dry-neutralizing step, to surface-modify the detergent granules. By surface-modifying the detergent granules, further improvements in the free-flowability and the storage stability of the resulting detergent granules can be attained, so that the surface-modifying step is preferably provided, for example, in a case where the present detergent granules are used as one component of a detergent composition. The surface modification is carried out by adding a surface modifier as a free-flowing aid, while blending the detergent granules in an agitation granulator (surface-modifying step).

As the surface modifiers, any of known, ordinarily used ones can be used, and a crystalline or amorphous alkali metal aluminosilicate (zeolite), calcite, diatomaceous earth, silica, or the like may be preferably used. The above aluminosilicate more preferably has an average particle size of 10 μm or less. Also, the amount of the surface modifier in the final product detergent composition is preferably from 5 to 50% by weight, and more preferably from 7 to 40% by weight. Incidentally, the average particle size of the surface modifier is calculated on volume basis, which is a value determined with a laser diffraction type particle size distribution analyzer LA-500 (manufactured by HORIBA, Ltd.).

Also, the operating time of the agitation granulator in cases where a surface modifier is added is not particularly limited, and the operating time is preferably from 1 to 5 minutes.

Incidentally, in the present process, the desired liquid components may be added depending upon the composition of a detergent composition to be obtained (step of adding liquid components). The timing of the addition of the liquid components is not particularly limited. The liquid components may be added prior to or during the course of the dry-neutralizing step, or alternatively after the dry-neutralizing step. It is preferred that the timing of addition is prior to the addition of the surface modifier. However, in some cases where the detergent granules obtained after the addition of the liquid components have excellent free-flowability and/or excellent storage stability, it is not necessary to add a surface modifier that serves as a free-flowing aid.

The liquid component includes, for example, any optional liquid components used in detergent compositions, including nonionic surfactants; water-soluble polymers (polyethylene glycol, acrylic acid-maleic acid copolymers, and the like); water, and the like. The liquid components may be used as a single component or a combination of two or more components. From the viewpoint of inhibiting the agglomeration of the detergent composition, the amount of the liquid components is preferably 20% by weight or less, and more preferably 15% by weight or less, of the final product detergent composition.

Further, in the present invention, a known substance generally employed in detergent compositions may be also added to and blended with the detergent granules after the dry-neutralizing step. For example, these substances may be added prior to the step of adding liquid components and/or to the surface-modifying step. The substance includes tripolyphosphates; crystalline or amorphous alkali metal aluminosilicates; crystalline silicates; calcium carbonate; fluorescers; pigments; anti-redeposition agents (polycarboxylate polymers, carboxymethyl cellulose sodium, and the like); granular surfactants (fatty acids or salts thereof, alkyl sulfates, and the like); spray-dried powders, diatomaceous earth, calcite, kaolin, bentonite, sodium sulfite, soap, and the like. The substance may be optionally used depending upon the application of the granules.

Also, the operating time of the agitation granulator in cases where the addition of the liquid components precedes the addition of the surface modifier is not particularly limited, and the operating time is preferably from 0.5 to 8 minutes.

Specifically, the process for producing the detergent granules of the present invention includes the following embodiments as preferred embodiments:
(1) an embodiment further including the step, after the step of carrying out dry-neutralization, of adding a liquid component; and
(2) an embodiment further including the step, after the step of adding a liquid component in the embodiment (1), of adding a free-flowing aid, to surface-modify the detergent granules.

The hue of the surface-modified, detergent granules as described above is not particularly limited. For example, in the case where the particle size of the surface-modified, detergent granules is evenly sized at 350 to 500 μm and the above detergent granules is analyzed by photoelectric calorimeter, it is preferable that the L value of the Hunter Lab coloration system is 90 or more.

In the present invention, other optional components may be further added to the detergent granules described above. The optional components include, for example, enzymes, perfumes, bleaching agents, pigments, and the like. The optional components may be formulated by blending the detergent granules obtainable by the process of the present invention with the above components using a mixer, such as a rotary mixer.

Modes for carrying out the present invention are not limited to the above processes. In other words, the present invention is applicable to the known powdery detergent compositions having high bulk density obtained by the dry-neutralization of the LAS-S and to known processes for producing the manufactured articles.

The feature of the detergent granules of the present invention thus obtained is in that detergent granules containing a LAS-Na, sodium sulfate undetected by X-ray diffraction method and sodium sulfate detected by X-ray diffraction method, wherein a molar ratio of [sodium sulfate undetected by X-ray diffraction method]/[LAS-Na] is from 0.1 to 1.0, and a molar ratio of [sodium sulfate detected by X-ray diffraction method]/[chemically quantified sodium sulfate] is from 0.5 to 0.9.

The largest feature of the detergent granules of the present invention is in that not all the sodium sulfate but a part of the sodium sulfate is detected by X-ray diffraction method, i.e. sodium sulfate detected by X-ray diffraction method and sodium sulfate undetected by X-ray diffraction method exist.

The phrase “a part of the sodium sulfate is detected by X-ray diffraction method” as used herein means that in an analysis of a sample according to X-ray diffraction method, the content of the sodium sulfate quantified is smaller than the content obtained by chemical quantification method described later.

Among the sodium sulfates in the detergent granules, although the details have not been elucidated, the reasons why a part of the sodium sulfate is undetected by X-ray diffraction method are considered to be as follows. A LAS-S and sulfuric acid is previously blended upon neutralization, thereby blending these neutralized products (LAS-Na and sodium sulfate) in a molecular level, whereby a crystal structure that is capable of being detected by X-ray diffraction method cannot be taken.

The X-ray diffraction method was carried out as follows. The X-ray diffraction was determined at room temperature with a powder X-ray diffractometer (XRD) (RINT 2500VPC, manufactured by Rigaku Corporation, light source Cu Kα, tube voltage: 40 kV, and tube electric current: 120 mA) under the conditions of a scanning interval of 0.010 in the range of 2θ=5° to 50°, a scanning speed of 10°/minute, a divergence vertical limiting slit of 10 mm, a divergence slit of 1°, a light-intercepting slit of 0.3 mm, and a scattering slit being automatic.

For example, the X-ray diffraction pattern of the detergent granules of Example 1 set forth below is identified as a mixture of sodium sulfate assignable to No. 37-1465, 4A-type zeolite assignable to No. 39-0222, and sodium carbonate assignable to No. 19-1130, each No. being in JCPDS (FIG. 1).

On the other hand, the content of the inorganic salt in the detergent granules can be chemically quantified by an analytical means, including, for example, ion chromatography or the like. For example, in a case where the inorganic salt is a sulfate, the sulfate contained in the detergent granules can be quantified by using a calibration curve of sulfate ions prepared in advance by an analyzing means, including, for example, ion chromatography or the like. In the detergent granules of the present invention, the sulfate contained in the granules can also be chemically quantified.

In the present invention, the determination of ion chromatography was carried out as follows. Ten milliliters of a 1000 mg/L sulfate ion standard solution (for ion chromatography) is accurately taken, and ion- exchanged water is added to make up a total volume of 100 mL. This solution is sequentially diluted to prepare each of 10, 20, 30, 40 and 50 mg/L solutions, and subjected to ion chromatography to draw up a calibration curve. The determination was made under the conditions of apparatus: ION CHROMATO 320, manufactured by Dionex, column: IonPac AS11-HG, AG11-HG, eluent: 10 to 40 mmol/L (0 to 25 minutes) KOH (EG40 used), flow rate: 1.5 ml/min, thermostat temperature: 35° C., detector: electroconductivity, and suppressor: ASRS (200 mA). A sample is obtained by adding ion-exchanged water to 2 g of a detergent to make up a total volume of 200 mL, and the mixture is stirred for 20 minutes. Thereafter, liquid paraffin is added thereto in a proper amount, and the mixture is heated in a water bath at about 80° C. for 30 minutes to dissolve, and the heated mixture is cooled, and thereafter 10 mL of the supernatant of this cooled solution is accurately taken, and ion-exchanged is added thereto to make up a total volume of 100 mL, and 25 μL of the amount of the sample introduced is subjected to ion chromatography.

In addition, the quantification of the LAS-Na can be carried out by using, for example, qualitative and quantitative methods for an anionic surfactant according to a synthetic detergent test method (JIS K3362).

Further, the amount of the powdery anhydrous sodium sulfate can be obtained from X-ray diffraction pattern of a detergent as shown in FIGS. 2 and 3. Here, “sodium sulfate detected by X-ray diffraction method” can be quantified by using an average of X-intercepts obtained from each of regression curves when plotting the diffraction intensity of the most intensive peak (d=2.784) and the second most intensive peak (d=4.658) of No. 37-1465 (sodium sulfate) of JCPDS from the diffraction intensity distribution are plotted on the ordinate. Specifically, each of 3.1% or 8.3% of powdery anhydrous sodium sulfate was added to detergent granules of Example 4 given below immediately before subjecting to X-ray diffraction method, and evenly mixed, and thereafter X-ray diffraction intensity distribution was obtained (FIG. 2). The amount of the powdery sodium sulfate was plotted on the abscissa, and the diffraction intensity of the most intensive peak (d=2.784) of No. 37-1465 (sodium sulfate) of JCPDS was plotted on the ordinate, and an X-intercept of the regression curve was obtained to be −4.28 (FIG. 3). Similarly, an X-intercept obtained from the data from the second most intensive peak (d=4.658) was −5.07. An average of two X-intercepts is −4.68%, so that it can be seen that the average almost agrees to a reciprocal of 4.55%, which is the amount of powdery anhydrous sodium sulfate contained in the detergent granules of Example 4. As described above, the powdery anhydrous sodium sulfate originally contained in the sample can be quantified by adding the powdery anhydrous sodium sulfate to a sample in which the amount of the powdery anhydrous sodium sulfate is unknown, and obtaining X-ray diffraction intensity thereof. As described above, the molar ratio of [sodium sulfate detected by X-ray diffraction method]/[chemically quantified sodium sulfate] can be obtained. Here, the phrase “chemically quantified sodium sulfate” refers to sodium sulfate quantified by an analytical means, including, for example, ion chromatography or the like.

The detergent granules of the present invention are detergent granules containing a LAS-Na, sodium sulfate undetected by X-ray diffraction method and sodium sulfate detected by X-ray diffraction method, wherein a molar ratio of [sodium sulfate undetected by X-ray diffraction method]/[LAS-Na] is from 0.1 to 1.0, and a molar ratio of [sodium sulfate detected by X-ray diffraction method]/[chemically quantified sodium sulfate] is from 0.5 to 0.9.

Regarding the [sodium sulfate undetected by X-ray diffraction method]/[LAS-Na], the molar ratio is 0.1 or more, and preferably 0.15 or more, from the viewpoint of suppression of the formation of coarse granules of the detergent granules, and the molar ratio is 1.0 or less, preferably 0.8 or less, and more preferably 0.65 or less, from the viewpoint of degree of the compositional freedom of the detergent composition.

Regarding the [sodium sulfate detected by X-ray diffraction method]/[chemically quantified sodium sulfate], the molar ratio is 0.5 or more, and preferably 0.6 or more, from the viewpoint of suppression of the formation of paste in a washing machine, and the molar ratio is 0.9 or less, and preferably 0.88 or less, from the viewpoint of suppression of the formation of coarse granules of the detergent granules.

Further, the amount of the alkali metal aluminosilicate in the dry-neutralizing step is preferably 5% by weight or less, and more preferably 3% by weight or less, of the final detergent composition.

The detergent granules of the present invention as described above have the properties of (1) overcoming the problem of paste formation, and (2) generating smaller amount of heat upon hand-washing. The detailed properties of the detergent granules of the present invention will be explained hereinbelow.

(1) Paste Formability

The present inventors have found that the detergent granules of the present invention exhibit very low paste formability.

Here, paste formability can be evaluated using a washing machine.

Eighteen grams of a detergent is placed on a pulsator disposed at the bottom of a washing tank of a fully automatic washing machine (manufactured by National Panasonic, pulsator-type, full water volume: 45 L, low water level: 21 L, with high-low agitation strength switches), so as to spread the detergent in a diameter of about 5 cm, and water (10° C.) is introduced into the washing tank to the low water level in a manner that water flow does not directly hit the detergent. After 5 minutes passed from the introduction of water, the agitation under weak water flow is started, and stopped after 2 minutes, and water is drained from the washing tank. The shape of the detergent remaining in the internal of the washing tank is visually judged.
<Evaluation>
◯: no residue;
Δ: residue having a diameter of 3 cm or less; and
X: residue having a diameter exceeding 3 cm.

The formation of paste is considered to be related to the particle size and the dissolution rate of the detergent.

When a large paste remains in a washing tank, the paste is deposited to clothes, thereby causing a disadvantage such as generating chapped skin upon wearing clothes. Therefore, a detergent having low paste formability is desired.

None of Examples set forth below have residue, so that it can be seen that Examples are more excellent than Comparative Examples.

(2) Exothermic Property upon Hand-Washing

The present inventors have found that the detergent granules of the present invention exhibit highly excellent exothermic (heat-generating) property.

Generation of heat upon hand-washing can be felt by hands when actually washing. However, since quantitative measurement is difficult, the evaluation is carried out with a model system, to take a correlation between the value and hand-washing. When the temperature increase in the model system described later exceeds 10° C., it is felt “hot” in actual hand-washing. The inventive products are sufficiently lower than this value.

The determination with the model system was carried out as described hereinbelow. Twenty-five grams of a detergent and 25 g of water are temperature-controlled each to room temperature. The detergent and water are mixed in a cup made of foaming polystyrol, and the temperature of the mixture is determined with a thermocouple-type digital thermometer. The temperature initially increases dramatically, reaches the highest temperature in usually from one to several minutes, and then decreases. The highest temperature is recorded, and a difference with room temperature is obtained, and the difference is defined as a temperature increase (unit: ° C.).

Temperature increase in Examples set forth below is all from 6° to 8° C., satisfying the intended value of 10° C. or less.

The amount of the LAS-Na can be properly set depending upon the components of the desired detergent composition. The amount of the LAS-Na formed by the neutralization reaction is preferably from 10 to 40% by weight, more preferably from 12 to 35% by weight, and even more preferably from 15 to 30% by weight, of a final product detergent composition. The above range is a range in which the effects of the present invention are remarkably exhibited.

In addition, the amount of the LAS-Na, is preferably 10% by weight or more and less than 40% by weight, and more preferably from 15 to 30% by weight, of the detergent granules, as a necessary and sufficient amount in order to obtain given detergency and foaming.

In addition, the detergent granules of the present invention, or the high-bulk density detergent composition containing the detergent granules obtainable by the process of the present invention has a bulk density of 500 g/L or more, and more preferably has the following physical properties.

Bulk density: Those having a bulk density of from 650 to 950 g/L are preferable. In the present specification, the bulk density is a value evaluated by the method defined in JIS K 3362.

Particle size: The average particle size is preferably 700 μm or less, and more preferably from 300 to 600 μm, from the viewpoint of dissolution rate of the detergent granules. In the present specification, the average particle size of the detergent composition is evaluated from the weight percentages depending on the sizes of the sieves after vibrating a standard sieve according to JIS K 8801 for five minutes.

Free-flowability: The flow time is defined as a time period required for allowing 100 mL of powder to flow out of a hopper used in a measurement of bulk density as prescribed in JIS K 3362.

The high-bulk density detergent composition of the present invention can be prepared by adding the above-mentioned detergent granules and a known substance generally used in a detergent composition after a dry-neutralization step, and mixing the components.

The above-mentioned high-bulk density detergent composition can be suitably used for laundry detergents, industrial detergents, and the like.

### EXAMPLES

The present invention will be described more specifically by means of Examples and Comparative Examples, without intending to limit the present invention to these Examples and the like.

### Example 1

The detergent composition having the composition shown in Table 1 was produced in an amount of 35 kg for each unit using a high speed mixer “Lödige Mixer FKM-130D” (manufactured by Matsubo Co., Ltd.). This mixer was equipped with agitation blades and a shearing device, the shearing device corresponding to a chopper for disintegration and dispersion.

Here, the procedures were carried out as detailed hereinbelow.

<Powder Blending>

The solid ingredients consisting of 12.03 parts by weight of sodium carbonate (“LIGHT ASH,” manufactured by Central Glass Co., Ltd.; average particle size: 56.1 μm), 3.50 parts by weight of a powdery anhydrous sodium sulfate (“Neutral Anhydrous Sodium Sulfate,” manufactured by Shikoku Kasei K.K., average particle size: 110 μm), and 0.11 parts by weight of a fluorescer were blended for one minute with the Lödige Mixer under the conditions of a rotational speed of agitation blades of 130 rpm (peripheral speed: 3.4 m/s) and a rotational speed of shearing device of 2850 rpm (peripheral speed: 27 m/s).

<Neutralization>

While the mixer was operated under the same conditions as above, 5.80 parts by weight of a LAS-S and 0.40 parts by weight of a 98% by weight sulfuric acid that were mixed in advance were added to the mixer in four minutes. During the addition, the ingredients were cooled by allowing water at 25° C. to flow through the mixer jacket. At this stage, the temperature rose to 75° C. at highest. Incidentally, through this stage, the reaction mixture remained in a granular form. Incidentally, the LAS mentioned above was produced by SO₃ gas sulfonation process, and contained 0.09 parts by weight of sulfuric acid. In other words, sulfuric acid was contained in an amount of 0.05 mol per one mol of the LAS-S. Also, the proportion of sulfuric acid to the. LAS-S during neutralization was such that the reaction mixture contained 0.29 mol of sulfuric acid per one mol of the LAS-S. The amount of sodium carbonate was about eight times the amount required for neutralizing the LAS-S and sulfuric acid.

After the addition of the LAS, the mixer was continuously operated under the same conditions for one minute. A fatty acid (14 to 18 carbon atoms, titer at 40° to 50° C.) was further added thereto in an amount of 0.48 parts by weight, and the mixer was operated under the same conditions for one minute to complete the neutralization reaction and the granulation process.

In addition, the mixture was subjected to aeration (300 L per minute) during the period from immediately after the addition of the LAS-S to the completion of the neutralization reaction. A total weight of the granular product (sodium carbonate, powdery anhydrous sodium sulfate, and fluorescer) at this stage was 15.64 kg, and the weight of air (25° C.) was 355 g per minute, i.e. the aeration was 2.3 parts by weight based on 100 parts by weight of the granular product.

<Addition of Liquid Components>

A nonionic surfactant (EO adduct of a primary alcohol, 12 to 14 carbon atoms, number of moles of ethylene oxide: 6 mol) was further added thereto in an amount of 2.10 parts by weight, and the mixture was blended for one minute. Thereafter, a 40% by weight aqueous solution of an acrylic acid-maleic acid copolymer was added to the mixer in an amount of 0.88 parts by weight, and the ingredients were mixed for 1 minute and 30 seconds. Subsequently, zeolite (10.50 parts by weight) was added thereto, and the mixer was operated for additional 2 minutes. Here, the above zeolite contained 1.05 parts by weight of water of crystallization.

<After-Blending>

Enzymes (0.18 parts by weight) and the detergent composition obtained above were blended with a rotary mixer, and thereafter perfume (0.07 parts by weight) was sprayed to the mixture, to give a final powder of the high-bulk density detergent composition.

The resulting granules of the detergent composition had a 1180 μm-sieve passed percentage of 78.3%, an average particle size of 505 μm, a bulk density of 855 g/L, and free-flowability of 5.7 seconds. In addition, the granules had paste formability of ◯ (no residue), exothermic property of 8° C., and a water-insoluble content of 0.1% by weight, so that the granules had excellent quality (Table 2).

### Example 2

The same procedures as in Example 1 were carried out except for changing the weight ratios of the used ingredients as shown in Table 1, to give a detergent composition.

The resulting granules of the detergent composition had a 1180 μm-sieve passed percentage of 69.1%, an average particle size of 620 μm, a bulk density of 790 g/L, and free-flowability of 6.8 seconds. In addition, the granules had paste formability of ◯ (no residue), exothermic property of 6° C., and a water-insoluble content of 0.1% by weight, so that the granules had excellent quality (Table 2).

Here, the proportion of sulfuric acid to the LAS-S during neutralization was such that the reaction mixture contained 0.61 mol of sulfuric acid per one mol of the LAS-S. The amount of sodium carbonate was about five times the amount required for neutralizing the LAS-S and sulfuric acid.

### Example 3

The same procedures as in Example 1 were carried out except for changing the weight ratios of the used ingredients as shown in Table 1, to give a detergent composition. Here, STPP in Table 1 stands for sodium tripolyphosphate.

The resulting granules of the detergent composition had a 1180 μm-sieve passed percentage of 65.8%, an average particle size of 639 μm, a bulk density of 825 g/L, and free-flowability of 6.1 seconds. In addition, the granules had paste formability of ◯ (no residue), exothermic property of 8° C., and a water-insoluble content of 0.1% by weight, so that the granules had excellent quality (Table 2).

Here, the proportion of sulfuric acid to the LAS-S during neutralization was such that the reaction mixture contained 0.24 mol of sulfuric acid per one mol of the LAS-S. The amount of sodium carbonate was about four times the amount required for neutralizing the LAS-S and sulfuric acid.

### Example 4

The same procedures as in Example 1 were carried out except for changing the weight ratios of the used ingredients as shown in Table 1, to give a detergent composition.

The resulting granules of the detergent composition had a 1180 μm-sieve passed percentage of 63.1%, an average particle size of 522 μm, a bulk density of 797 g/L, and free-flowability of 8.0 seconds. In addition, the granules had paste formability of ◯ (no residue), exothermic property of 8° C., and a water-insoluble content of 0.1% by weight, so that the granules had excellent quality (Table 2).

Here, the proportion of sulfuric acid to the LAS-S during neutralization reaction was such that the reaction mixture contained 0.28 mol of sulfuric acid per one mol of the LAS-S. The amount of sodium carbonate was about eight times the amount required for neutralizing the LAS-S and sulfuric acid.

### Comparative Example 1

The same procedures as in Example 1 were carried out except for changing the weight ratios of the used ingredients as shown in Table 1, to give a detergent composition.

The resulting granules of the detergent composition had a 1180 μm-sieve passed percentage of 84.7%, an average particle size of 319 μm, a bulk density of 800 g/L, and free-flowability of 7.4 seconds. In addition, the granules had paste formability of X (granules having a diameter of 5 cm remaining), and exothermic property of 14° C., so that the properties were inferior to those of Example 1 (Table 2).

Here, the amount of sodium carbonate was about eleven times the amount required for neutralizing the LAS-S and sulfuric acid.

### Comparative Example 2

The same procedures as in Example 1 were carried out except for changing the weight ratios of the used ingredients as shown in Table 1, to give a detergent composition.

The resulting granules of the detergent composition had a 1180 μm-sieve passed percentage of 55.9%, an average particle size of 858 μm, a bulk density of 811 g/L, and free-flowability of 6.7 seconds. In addition, the granules had paste formability of X (granules having a diameter of 5 cm remaining), and exothermic property of 12° C., so that the properties were inferior to those of Example 1 (Table 2).

Here, the amount of sodium carbonate was about seven times the amount required for neutralizing the LAS-S and sulfuric acid.

### Comparative Example 3

The same procedures as in Example 1 were carried out except for changing the weight ratios of the used ingredients as shown in Table 1, to give a detergent composition.

The resulting granules of the detergent composition had a 1180 μm-sieve passed percentage of 80.6%, an average particle size of 394 μm, a bulk density of 636 g/L, and free-flowability that was undeterminable. In addition, the granules had paste formability of X (granules having a diameter of 5 cm remaining), exothermic property of 16° C., and a water-insoluble content of 0.6%, so that the properties were inferior to those of Example 1 (Table 2).

Here, the amount of sodium carbonate was about nine times the amount required for neutralizing the LAS-S and sulfuric acid.

TABLE 1

| | Examples | | | | Comparative Examples | | |
|---|---|---|---|---|---|---|---|
| Amount of Formulation (parts by weight) | 1 | 2 | 3 | 4 | 1 | 2 | 3 |

Powder-Blending Step

| | | | | | | | |
|---|---|---|---|---|---|---|---|
| Sodium Carbonate | 12.03 | 8.91 | 11.29 | 12.32 | 15.53 | 14.16 | 16.96 |
| STPP | — | — | 5.60 | — | — | — | — |
| Powdery Anhydrous Sodium Sulfate | 3.50 | 5.25 | 5.25 | 1.59 | — | — | — |
| Sodium Hydrogencarbonate | — | 2.80 | — | — | — | 2.80 | — |
| Zeolite | — | — | — | — | — | — | 3.50 |
| Fluorescer | 0.11 | 0.11 | 0.11 | 0.11 | 0.11 | 0.11 | 0.11 |

Neutralizing Step

| | | | | | | | |
|---|---|---|---|---|---|---|---|
| LAS-S | 5.80 | 5.46 | 10.24 | 6.14 | 5.80 | 5.46 | 5.46 |
| 98% Sulfuric Acid | 0.40 | 0.90 | 0.58 | 0.41 | 0.40 | 0.90 | 0.90 |
| Fatty Acid | 0.48 | — | — | 0.48 | 0.48 | — | — |

After Neutralizing Step

| | | | | | | | |
|---|---|---|---|---|---|---|---|
| Nonionic Surfactant | 2.10 | 1.75 | — | 2.10 | 2.10 | 1.75 | 1.75 |
| 40% Copolymer | 0.88 | 1.31 | 0.44 | 0.88 | 0.88 | 1.31 | 1.31 |
| Zeolite | 10.50 | 9.80 | 2.10 | 11.73 | 10.50 | 9.80 | 6.30 |
| Enzymes | 0.18 | 0.18 | 0.18 | 0.18 | 0.18 | 0.18 | 0.18 |
| Perfume | 0.07 | 0.07 | 0.07 | 0.07 | 0.07 | 0.07 | 0.07 |
| Molar Ratio (Sulfuric Acid/LAS-S) | 0.29 | 0.61 | 0.24 | 0.28 | 0.29 | 0.61 | 0.61 |
| Molar Ratio (Powdery Anhydrous Sodium Sulfate/Total of | 0.83 | 0.79 | 0.83 | 0.69 | 0.00 | 0.00 | 0.00 |
| Powdery Anhydrous Sodium Sulfate and Sulfuric Acid) | | | | | | | |
| Molar Ratio (Sodium Sulfate Detected by X-ray Diffraction | 0.8 | 0.8 | 0.8 | 0.7 | 0.0 | 0.0 | 0.0 |
| Method/Chemically Quantified Sodium Sulfate) | | | | | | | |
| Molar Ratio (Sodium Sulfate Undetected by X-ray | 0.3 | 0.6 | 0.2 | 0.3 | 0.3 | 0.6 | 0.6 |
| Diffraction Method/LAS-Na) | | | | | | | |

The amount of formulation is expressed by parts by weight.

TABLE 2

| | Examples | | | | Comparative Examples | | |
|---|---|---|---|---|---|---|---|
| Components (% by weight) | 1 | 2 | 3 | 4 | 1 | 2 | 3 |
| LAS-Na | 17.00 | 16.00 | 30.00 | 18.00 | 17.00 | 16.00 | 16.00 |
| Soap | 1.50 | — | — | 1.50 | 1.50 | — | — |
| STPP | — | — | 16.00 | — | — | — | — |
| Zeolite | 30.00 | 28.00 | 6.00 | 33.50 | 30.00 | 28.00 | 28.00 |
| Sodium Carbonate | 30.00 | 20.00 | 25.40 | 30.90 | 40.00 | 35.00 | 43.00 |
| Sodium Hydrogencarbonate | — | 8.00 | — | — | — | 8.00 | — |
| Sodium Sulfate (Neutralization of free sulfuric acid | 2.00 | 4.00 | 3.00 | 2.05 | 2.00 | 4.00 | 4.00 |
| in sulfuric acid and LAS) | | | | | | | |
| Powdery Anhydrous Sodium Sulfate | 10.00 | 15.00 | 15.00 | 4.55 | — | — | — |
| Copolymer | 1.00 | 1.50 | 0.50 | 1.00 | 1.00 | 1.50 | 1.50 |
| Nonionic Surfactant | 6.00 | 5.00 | — | 6.00 | 6.00 | 5.00 | 5.00 |
| Fluorescer | 0.30 | 0.30 | 0.30 | 0.30 | 0.30 | 0.30 | 0.30 |
| Enzymes | 0.50 | 0.50 | 0.50 | 0.50 | 0.50 | 0.50 | 0.50 |
| Perfume | 0.20 | 0.20 | 0.20 | 0.20 | 0.20 | 0.20 | 0.20 |
| Water | 1.50 | 1.50 | 3.10 | 1.50 | 1.50 | 1.50 | 1.50 |

Evaluation of Properties

| | | | | | | | |
|---|---|---|---|---|---|---|---|
| Paste Formability (10° C.) | ∘ | ∘ | ∘ | ∘ | x | x | x |
| Exothermic Property | 8° C. | 6° C. | 8° C. | 8° C. | 14° C. | 12° C. | 16° C. |
| (Powder:Water = 1:1, Δt) | | | | | | | |
| Water-Insoluble Content (%) | 0.1 | 0.1 | 0.1 | 0.1 | 0.1 | 0.1 | 0.6 |

### INDUSTRIAL APPLICABILITY

A detergent composition having low paste formability and low heat of dissolution can be obtained by neutralizing a LAS-S with a water-soluble solid alkali inorganic substance in the presence of a given amount of sulfuric acid and a given amount of a powdery sodium sulfate.

### BRIEF DESCRIPTION OF THE DRAWINGS

FIG. 1 is a chart showing an X-ray diffraction pattern of the detergent granules of Example 1 and Comparative Example 2. It can be seen that 4A-type zeolite assignable to No. 39-0222, and sodium hydrogencarbonate assignable to No. 19-1130 of JCPDS are contained in all the detergent granules, that sodium sulfate assignable to No. 37-1465 is contained only in Example 1, and that sodium carbonate assignable to No. 15-0700 is contained only in Comparative Example 2.

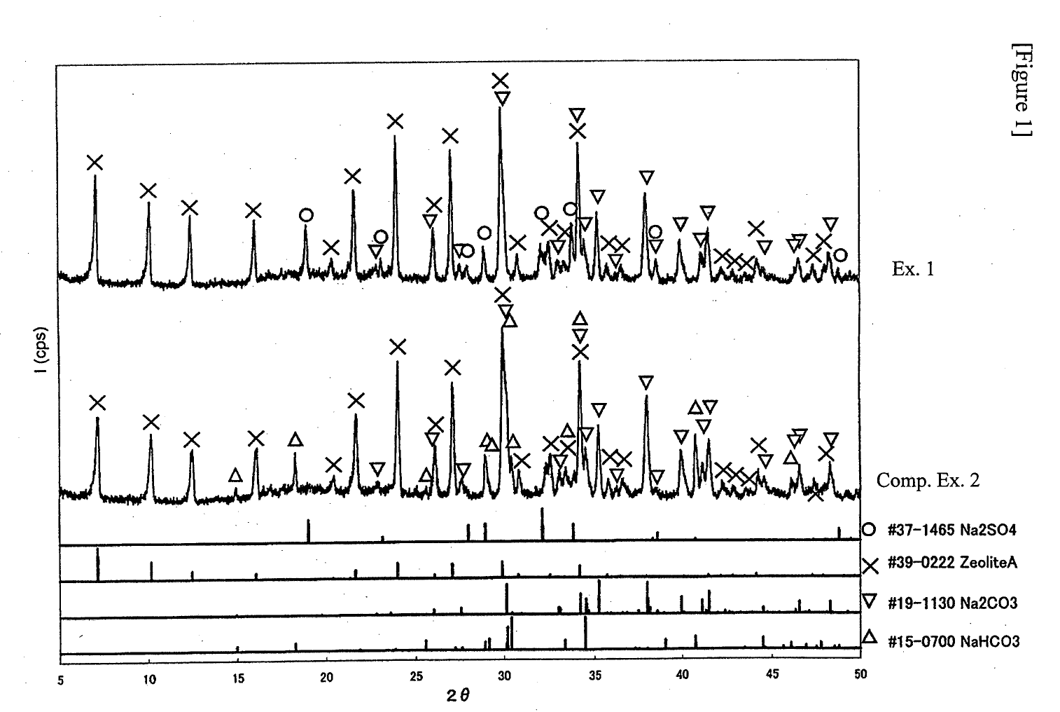

FIG. 2 is a chart in which diffraction intensity distributions are obtained after adding 3.1% and 8.3%, respectively, of a powdery anhydrous sodium sulfate to the detergent granules of Example 4 immediately before carrying out the X-ray diffraction method, and homogeneously mixing the components, and shown together with the diffraction intensity distribution of Example 4.

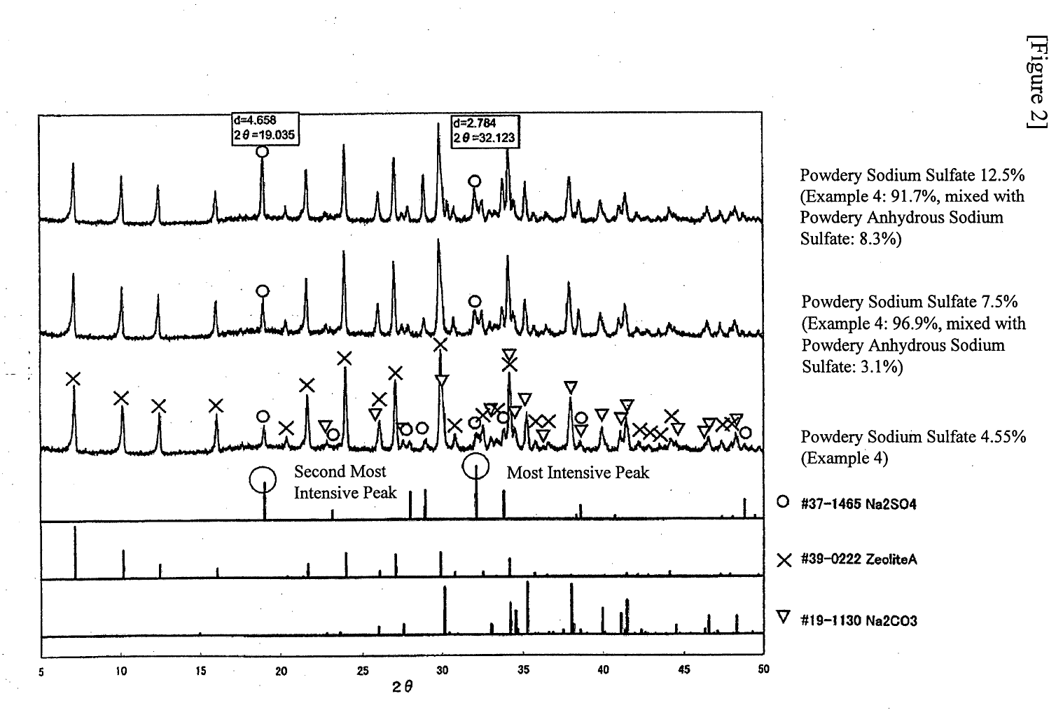

FIG. 3 is a chart in which the amount of the powdery sodium sulfate added to Example 4 is plotted as the abscissa, and the diffraction intensity of the most intensive peak (d=2.784) and the second most intensive peak (d=4.658) of No. 37-1465 (sodium sulfate) of JCPDS from the diffraction intensity distribution of FIG. 2 are plotted as the ordinate, and X-intercepts for each of regression straight lines are obtained. It can be seen from FIGS. 2 and 3 that the powdery anhydrous sodium sulfate originally contained in the sample can be quantified by obtaining X-ray diffraction intensity obtained by adding powdery anhydrous sodium sulfate to a sample of which amount of the powdery anhydrous sodium sulfate is unknown.

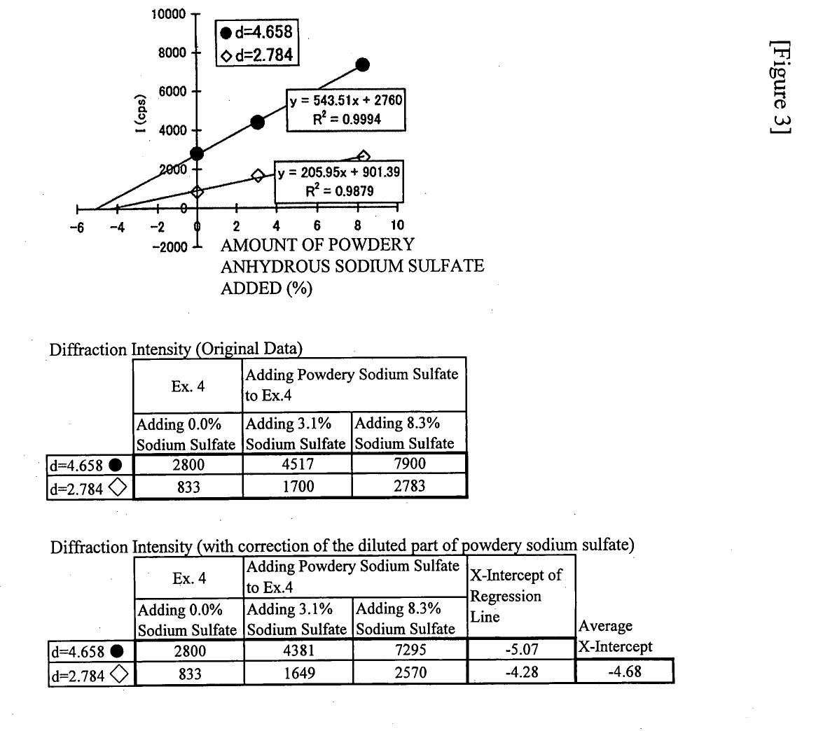

1. Detergent granules comprising a sodium linear alkylbenzenesulfonate (LAS-Na), sodium sulfate undetected by X-ray diffraction method and sodium sulfate detected by X-ray diffraction method, wherein a molar ration of [sodium sulfate undetected by X-ray diffraction method]/[LAS-Na] is from 0.1 to 1.0, and a molar ration of [sodium sulfate detected by X-ray diffraction method]/[chemically quantified sodium sulfate] is from 0.5 to 0.9.

2. The detergent granules according to claim 1 wherein the amount of LAS-Na is 10% by weight or more and less than 40% by weight of the detergent granules.

3. A process for producing detergent granules, comprising the step of dry-neutralizing a mixture of a liquid acid precursor of a sodium linear alkylbenzenesulfonate (LAS-S) and sulfuric acid with a water-soluble solid alkali inorganic substance in a mixture comprising powdery anhydrous sodium sulfate, wherein sulfuric acid is present in a ration of 0.1 to 1.0 mol to one mol of the LAS-S, and the powdery anhydrous sodium sulfate is present in a ration of from 0.5 to 0.9 mol to one mol of a total of the powdery anhydrous sodium sulfate and sulfuric acid.

4. The process according to claim 3, wherein the LAS-S is a linear alkylbenzenesulfonic acid obtainable by a SO₃ gas sulfonation process.

5. The process according to claim 3 or 4, wherein an amount of sulfuric acid that is previously present in the LAS-S is 0.09 mol or less to one mol of the LAS-S.

6. The process according to claim 3, wherein in a case where an alkali metal aluminosilicate is further added in the dry-neutralizing step, an amount of the alkali metal aluminosilicate is 5% by weight or less of the detergent granules.

7. A high-bulk density detergent composition having a bulk density of 500 g/L or more, comprising the detergent granules as defined in claim 1 or 2, or detergent granules obtainable by the process as defined in claim 3.

8. The process according to claim 4, wherein in a case where an alkali metal aluminosilicate is further added in the dry-neutralizing step, an amount of the alkali metal aluminosilicate is 5% by weight or less of the detergent granules.

9. The process according to claim 5, wherein in a case where an alkali metal aluminosilicate is further added in the dry-neutralizing step, an amount of the alkali metal aluminosilicate is 5% by weight or less of the detergent granules.
